(19) United States
(12) Patent Application Publication
(10) Pub. No.: US 2023/0329189 A1
(43) Pub. Date: Oct. 19, 2023

(54) HEADLOCK TYPE BARRIER

(71) Applicant: AGRITUBEL, LOUDUN (FR)

(72) Inventor: Philippe DUBOUIX, Loudun (FR)

(21) Appl. No.: 18/299,348

(22) Filed: Apr. 12, 2023

(30) Foreign Application Priority Data
Apr. 14, 2022 (FR) 2203461

(51) Int. Cl. A01K 1/062; A01K 1/06

(52) U.S. Cl. CPC A01K 1/062; A01K 1/0613; A61D 2003/003

(57) ABSTRACT

Disclosed is a headlock-type barrier including: an upper pole and a lower pole; a pair of vertical uprights connected to the lower pole and to the upper pole so as to define a frame; a swing arm which pivots relative to the frame about a first transverse axis, the swing arm including an arm and a fork which is integral with an upper end of the arm, the fork including a pair of prongs arranged transversely one on either side of the upper pole, the swing arm including a rod rigidly connected to each of the prongs, the rod being arranged above the upper pole; a locking mechanism including a plate fixed to the upper pole and on which are hinged a first and a second stop wedge between a deployed position and a retracted position.

### TECHNICAL FIELD

This description relates to a headlock-type barrier (also called cattle stanchion barrier).

### PRIOR ART

Headlock-type barriers are used to manage animal feeding and also to immobilize an animal in order to carry out certain interventions, in particular veterinary care.

A headlock-type barrier generally comprises an upper pole (or rail, or rod), a lower pole (or rail, or rod), and a plurality of vertical uprights each extending between the upper pole and the lower pole so as to define a plurality of frames. Each frame is therefore delimited vertically by the upper pole and lower pole and longitudinally by two adjacent vertical uprights.

Longitudinal direction means the direction in which the upper pole and the lower pole extend. The vertical direction corresponds to the direction of the earth's gravity field. The vertical direction is perpendicular to the longitudinal direction. Finally, the transverse direction corresponds to a direction perpendicular to the longitudinal direction and to the vertical direction. Furthermore, absolute position qualifiers such as “top”, “bottom”, etc., or relative position qualifiers such as “above”, “below”, “upper”, “lower”, etc., and orientation qualifiers such as “vertical” and “horizontal”, are in reference to the vertical direction as defined.

Each frame is fitted with a swing arm for restraining an animal. The swing arm is rotatable about a transverse axis of rotation, from an open position allowing the passage of the animal's head. The swing arm can be pivoted into a closed position defining a restricted passage which either allows denying access for an animal, or hobbling an animal by the neck. The swing arm can also be pivoted into a release position allowing the animal to access a trough to feed and/or to withdraw its head via the bottom of the frame.

Means may be provided to lock the swing arm in one of these positions, in particular in the closed position. According to a first solution described in document FR 2 750 292, the barrier comprises a bar extending longitudinally above the upper pole and the swing arm comprises a fork at its upper end. The fork comprises two prongs which are each arranged on a respective side of the bar in the transverse direction. The bar also comprises a notch in which a slider extending transversely between the prongs of the fork can be slotted under the effect of its own weight, thus making it possible to lock the rotation of the swing arm about its transverse axis of rotation. Conventionally, the slider is guided in translation between the prongs of the fork by being received, at each of its ends in the transverse direction, in a corresponding slot provided through each prong of the fork. Rotation of the bar around its axis of extension releases the slider from the notch and thus unlocks the swing arm.

Nevertheless, the first solution has the disadvantage that the locking of the swing arm is not certain to be obtained. In particular, when the swing arm pivots rapidly, the movement of the slider under the effect of its own weight is not fast enough to guarantee its insertion into the notch before the swing arm passes beyond the locking position. In addition, the rotation of the swing arm subjects the slider to a centrifugal force which at least partially opposes the force of gravity intended to ensure the movement of the slider towards the notch. Thus, the faster the rotation of the swing arm, the greater the risk that the swing arm will not be locked. Furthermore, the slots provided through the prongs of the swing arm fork and the notch provided on the bar can easily be obstructed by debris or residue, which also can cause the swing arm not to lock. Finally, the individual unlocking of a swing arm requires manual removal of the slider from the corresponding notch by a human operator. This operation presents a significant risk of injury to the human operator, however.

According to a second locking solution described in document FR 3 070 824, the barrier comprises a bar extending longitudinally above the upper pole and the swing arm comprises, at its upper end, a fork having two prongs between which a rod extends transversely. The rod is located, in the vertical direction, between the upper pole and the bar. The barrier further comprises a pair of stop wedges mounted in a hinged manner on the bar and adapted to cooperate with the rod under the effect of their own weight in order to lock the rotation of the swing arm about its transverse axis of rotation. Rotation of the bar about its axis of extension allows the stop wedges to be maneuvered into an inactive retracted position and thus unlocks the swing arm.

However, the second solution does not give complete satisfaction either for a robust locking of the swing arm. Indeed, in the arrangement of the second solution, the forces exerted by the animal on the swing arm when it is locked are first transmitted to each of the stop wedges. Therefore, if the forces exerted by the animal are significant, these may be prone to cause deformation or even breakage of the stop wedges, thus freeing the animal. Then the forces exerted by the animal on the swing arm are transmitted from the stop wedges to the bar, which can interfere with or even prevent maneuvering the bar. In addition, the bar can then be subjected to buckling forces which can also lead to release of the swing arm.

### SUMMARY OF THE INVENTION

This disclosure improves the situation.

A headlock-type barrier is proposed comprising:
an upper pole and a lower pole each extending in a longitudinal direction;
a pair of vertical uprights each connected to the lower pole and to the upper pole so as to define a frame,
a swing arm mounted so as to pivot relative to the frame about a first transverse axis, the swing arm comprising an arm and a fork which is integral with an upper end of the arm, the fork comprising a pair of prongs arranged one on either side of the upper pole in the transverse direction, the swing arm further comprising a rod rigidly connected to each of the prongs of the fork, the rod being arranged above the upper pole in the vertical direction,
a locking mechanism comprising a plate fixed to the upper pole and on which are hinged a first stop wedge and a second stop wedge, between a deployed position in which the first stop wedge and the second stop wedge are adapted to cooperate with the rod of the swing arm in order to block the pivoting of the swing arm about the first transverse axis in a locking position relative to the frame, and a retracted position in which the swing arm can pivot freely about the first transverse axis relative to the frame,
a control member adapted to move the first stop wedge and/or the second stop wedge from the deployed position to the retracted position.

Such a barrier makes it possible to obtain a robust locking of the swing arm in relation to the frame. In particular, the fork of the swing arm is devoid of any movable or sliding element necessary for locking the swing arm. Also, the risks of obstruction or clogging of the locking mechanism, due to residues, are reduced or even eliminated. Furthermore, such an arrangement allows the passage of the rod rigidly connected to each of the prongs to secure the prongs of the fork together, thus allowing an increased mechanical strength of the fork prongs.

The term “stop wedge” refers to movable stop elements (or “abutment” elements). When the first stop wedge and the second stop wedge are each in their retracted position, the swing arm can pivot about the first transverse axis without the rod striking the first stop wedge or the second stop wedge.

The plate can define an interior volume. The plate can comprise a first flange and a second flange assembled together so as to delimit the interior volume. Each stop wedge can be received wholly or in part within the interior volume defined by the plate. A compact locking mechanism is thus obtained.

The swing arm can in particular pivot between an open position allowing the passage of an animal's head in an upper part of the frame and a release position allowing the animal to access a trough to feed and/or to withdraw its head via a lower part of the frame.

In the locking position, the arm of the swing arm can extend in the vertical direction. Thus, in the locking position, the arm of the swing arm forms, with one of the vertical uprights, a passage whose spacing, in the longitudinal direction, is identical over the entire vertical dimension of the frame. This defines a closed position, which allows either denying access for an animal or hobbling the animal by the neck.

The path of the swing arm rod about the first transverse axis can form an arc of a circle encircling the plate of the locking mechanism.

The rod can extend in the transverse direction between the prongs of the fork.

In their deployed position, the first stop wedge and the second stop wedge can be adapted to prevent a circular movement of the swing arm rod about the first transverse axis. In particular, in their deployed position, the first stop wedge can be adapted to prevent a circular movement of the rod about the first transverse axis in a first direction of rotation and the second stop wedge can be adapted to prevent a circular movement of the rod about the first transverse axis in a second direction of rotation. The first stop wedge and the second stop wedge can each have, in their deployed position, a lateral or front face, forming an abutment able to prevent a circular movement of the swing arm rod about the first transverse axis, respectively in a first direction of rotation and in a second direction of rotation. In other words, the rod can be arranged longitudinally between the first stop wedge and the second stop wedge in order to prevent the swing arm from pivoting about the first transverse axis. It is not excluded that there be play in the longitudinal direction, on each side, between the rod and each stop wedge when the rod is arranged longitudinally between the first stop wedge and the second stop wedge in their deployed position. A simple and safe locking of the swing arm is thus ensured.

The first stop wedge and the second stop wedge can be hinged so as to pivot relative to the plate, respectively about a second transverse axis and a third transverse axis. Thus, the first stop wedge and the second pivot between the deployed position and the retracted position while remaining in a plane normal to the transverse direction which defines a plane of the barrier. In particular, this prevents the stop wedges from protruding on each side of the frame in the transverse direction when they pivot, i.e. outside the plane of the barrier, which would present a risk of injury to the animal or to the human operator.

When the first stop wedge and the second stop wedge are in the deployed position, a free space can be formed longitudinally between the first stop wedge and the second stop wedge, the free space being adapted to receive the swing arm rod. In particular, the free space can have a dimension measured in the longitudinal direction which enables each stop wedge to pivot between the deployed position and the retracted position when the swing arm rod is received in the free space. This prevents the swing arm rod from being pinched when each stop wedge pivots from the deployed position to the retracted position, which would cause the locking mechanism to jam.

In the deployed position and/or the retracted position, the first stop wedge and the second stop wedge can be in abutment against an inner face of the plate. Each stop wedge can comprise at least one lug intended to be in abutment against the inner face of the plate when the respective stop wedge is in the deployed position and/or the retracted position. The lug of each of the first stop wedge and second stop wedge in the deployed position can be in abutment against the inner face of the plate in the vertical direction. The first stop wedge and the second stop wedge can each comprise two lugs arranged on each side in the transverse direction.

The first stop wedge and/or the second stop wedge can each be adapted to be moved from the deployed position to the retracted position under the effect of the pivoting of the swing arm towards the locking position. This allows automatically moving the first stop wedge and/or the second stop wedge out of the way. The swing arm rod can thus be brought to cooperate with the first stop wedge and/or the second stop wedge without it being necessary to act directly and manually on the locking mechanism. Locking the swing arm is therefore easy and quick. In addition, the risk of injury to a human operator is avoided.

The first stop wedge and the second stop wedge can each have an upper face shaped so that the swing arm rod pressing on said upper face when the swing arm pivots towards the locking position is able to move the respective stop wedge from the deployed position to the retracted position. The upper face of each stop wedge can be inclined relative to the longitudinal direction. When the swing arm pivots about the first transverse axis towards the locking position, the rod can bear on the upper face of the first stop wedge in its deployed position or of the second stop wedge in its deployed position, depending on the direction of rotation of the swing arm about the first transverse axis, so as to rotate it by ramp effect, respectively about the second transverse axis or the third transverse axis.

The second stop wedge can be moved from the deployed position to the retracted position independently of movement of the first stop wedge. When an animal inserts its head into an upper part of the frame with the swing arm in its open position and lowers its head, the swing arm pivots about the first transverse axis to the release position. The rod can thus bear against the upper face of the second stop wedge in its deployed position so as to drive the stop wedge into its retracted position. The rod thus continues its path around the first transverse axis until it abuts against the first stop wedge.

The first stop wedge can cooperate with the second stop wedge so that a movement of the first stop wedge from the deployed position to the retracted position causes a movement of the second stop wedge from the deployed position to the retracted position. The unlocking of the swing arm can then be exerted by means of a single control member acting only on the first stop wedge.

Moving the second stop wedge from the retracted position to the deployed position can cause the first stop wedge to move from the retracted position to the deployed position.

The first stop wedge can comprise a projecting portion bearing in the vertical direction against a projecting portion of the second stop wedge. This reduces the space occupied by the locking mechanism. This makes it possible in particular to reduce the space occupied by the first stop wedge and second stop wedge inside the interior volume defined by the plate. The projecting portion of the first stop wedge can be U-shaped so as to cover the projecting portion of the second stop wedge. This also makes it possible to avoid displacement of one of the stop wedges relative to the other in the transverse direction.

The locking mechanism can comprise means adapted to ensure a return of the first stop wedge and second stop wedge to the deployed position. In the absence of external constraints, the first stop wedge and the second stop wedge are maintained in their deployed position. This allows a robust locking of the swing arm and an automatic return of the first stop wedge and second stop wedge to their deployed position. Thus, the first stop wedge and second stop wedge can be moved automatically from the retracted position to the deployed position when the swing arm is in the locking position.

The locking mechanism may solely comprise means to ensure a return of the second stop wedge to the deployed position. Said means can enable the return of the first stop wedge to the deployed position by means of the second stop wedge.

Said means can comprise elastic means. Elastic means are an economical and reliable solution for returning the first stop wedge and second stop wedge to the deployed position.

Said means can comprise a first torsion spring and a second torsion spring which are respectively interposed between the plate and first stop wedge and between the plate and second stop wedge.

Said means can be arranged inside the interior volume defined by the plate of the locking mechanism. Said means are thus better protected from the external environment and therefore wear out less quickly.

Said means can comprise a single torsion spring interposed between the plate and the second stop wedge. The torsion spring can allow the first stop wedge to return to the deployed position by means of the second stop wedge.

The control member can comprise a collective unlocking control which comprises a bar extending parallel to the upper pole, the bar being arranged, in the vertical direction, between the upper pole and the swing arm rod, and wherein a rotation of the bar about its axis of extension causes the first stop wedge and/or the second stop wedge to move from the deployed position to the retracted position.

The bar allows simultaneous control of a plurality of locking mechanisms carried by the upper pole. In particular, the bar can drive the first stop wedge and/or the second stop wedge to rotate about the second transverse axis and the third transverse axis respectively. Advantageously, the bar is not exposed to the forces induced by an animal on the swing arm. In addition, such an arrangement allows placing the bar as close as possible to the upper pole in the vertical direction, which makes it possible to further reduce the space occupied by the arrangement.

The bar can traverse the plate of the locking mechanism from one side to the other in the longitudinal direction. The mechanical connection connecting the bar to the first stop wedge and/or the second is thus better protected from the external environment. In addition, the bar only undergoes torsional forces. In particular, the bar does not undergo any bending force and does not undergo any cantilever force.

The collective unlocking control can comprise a cam rigidly mounted on the bar, the cam comprising a portion shaped to drive at least one among the first stop wedge and the second stop wedge to rotate respectively about the second transverse axis and the third transverse axis, directly or indirectly via a connecting member.

The first stop wedge and/or the second stop wedge can be moved from the deployed position to the retracted position by a rotation of the bar, about its axis of extension, which is less than or equal to a quarter turn. The bar can preferably pivot, about its axis of extension, over an angular sector equal to 45° so as to move the first stop wedge and/or the second stop wedge from the deployed position to the retracted position. Rotation of the bar over a small angular sector allows easy use of the bar by a user of the barrier.

The bar can have a cross-section having an anti-rotation profile, for example a square, polygonal, oval cross-section or any cross-section comprising flat portions. The cam can have a hole of a shape adapted to be associated with the bar due to complementary shapes and which allows integral rotation between bar and cam about the axis of extension of the bar.

The locking mechanism can comprise an individual unlocking control which comprises at least one push-button shaped to move one among the first stop wedge and the second stop wedge from the deployed position to the retracted position.

The individual unlocking control makes it possible to selectively unlock a locking mechanism, in particular when the barrier comprises a plurality of locking mechanisms carried by the upper pole. In particular, the push-button can drive the first stop wedge and/or the second stop wedge to rotate about the second transverse axis and the third transverse axis respectively.

The control member can comprise a connecting member mounted so as to pivot relative to the plate about a fourth transverse axis, the connecting member being interposed between the bar and one among the first stop wedge and the second stop wedge on the one hand, and between the push-button and said stop wedge among the first stop wedge and the second stop wedge on the other hand.

The first stop wedge and the second stop wedge can each be made of plastic. This reduces the level of noise emitted when the swing arm rod hits one of the stop wedges.

### BRIEF DESCRIPTION OF DRAWINGS

Other features, details, and advantages will become apparent upon reading the detailed description below, and upon analyzing the appended drawings, in which:

FIG. 1 shows a partial perspective view of a headlock-type barrier according to this description;

FIG. 2 shows a partial front view of the barrier of FIG. 1, which schematically represents the travel of the barrier's swing arm;

FIG. 3 shows a section view of part of FIG. 2 in section plane III-III;

FIG. 4 shows a front section view of the locking mechanism implemented in FIGS. 1 and 2, in a first configuration;

FIG. 5 shows a front section view of the locking mechanism implemented in FIGS. 1 and 2, in a second configuration;

FIG. 6 shows a front section view of the locking mechanism implemented in FIGS. 1 and 2, in a third configuration;

FIG. 7 shows a front section view of the locking mechanism implemented in FIGS. 1 and 2, in a fourth configuration;

FIG. 8 shows a perspective section view of the locking mechanism implemented in FIGS. 1 and 2, in the fourth configuration;

FIG. 9 shows a front section view of the locking mechanism implemented in FIGS. 1 and 2, in a fifth configuration;

FIG. 10 shows a perspective view of a first stop wedge and a second stop wedge implemented in the locking mechanism of FIGS. 4 to 9;

FIG. 11 comprises FIGS. 11a and 11b which show in perspective view a cam and a connecting member implemented in the locking mechanism of FIGS. 4 to 9, in two different configurations;

### DESCRIPTION OF THE INVENTION

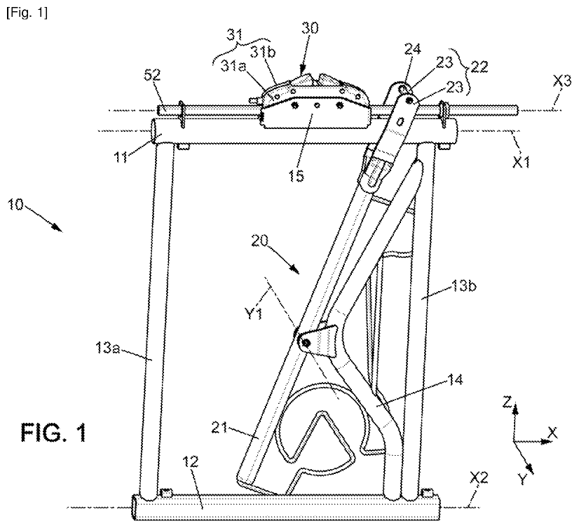

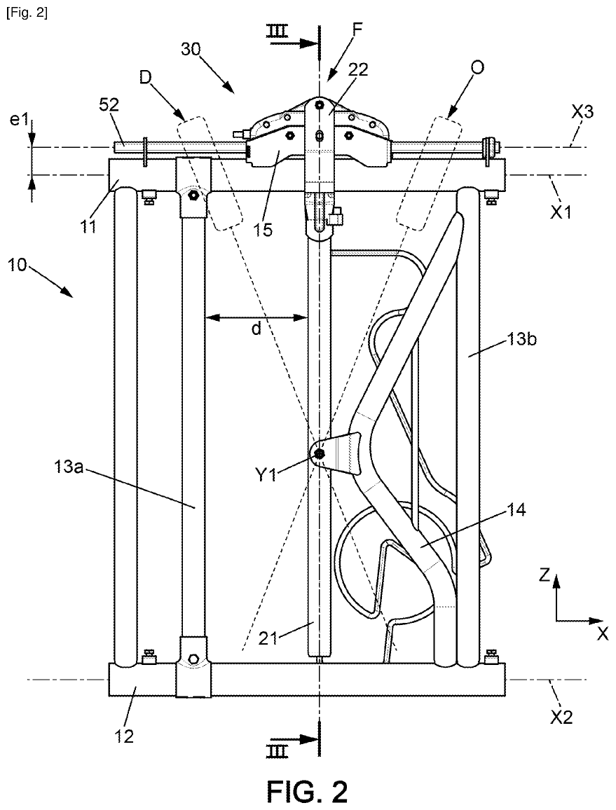

Reference is now made to FIGS. 1 to 3 which partially show a headlock-type barrier 10. Barrier 10 firstly comprises an upper pole 11 and a lower pole 12 each extending in a longitudinal direction X. Upper pole 11 extends along a first longitudinal axis X1 and lower pole 12 extends along a second longitudinal axis X2. First longitudinal axis X1 and second longitudinal axis X2 define a plane of barrier 10.

As above, in the following description the longitudinal direction X means the direction in which upper pole 11 and lower pole 12 extend. The vertical direction Z corresponds to the direction of the Earth's gravity field. Vertical direction Z is perpendicular to longitudinal direction X. Lastly, transverse direction Y corresponds to a direction perpendicular to longitudinal direction X and to vertical direction Z. In addition, the absolute position qualifiers, such as the terms “top”, “bottom”, etc., or relative position qualifiers, such as the terms “above”, “below”, “upper”, “lower”, etc., and the orientation qualifiers, such as the terms “vertical” and “horizontal”, are in reference to vertical direction Z as defined and, unless otherwise specified, to the orientation of the figures.

Barrier 10 comprises a first vertical upright 13a and a second vertical upright 13b each extending in vertical direction Z. The vertical uprights are each connected to lower pole 12 and to upper pole 11. Lower pole 12, upper pole 11, and the pair of vertical uprights 13a, 13b thus define a frame. Barrier 10 further comprises an angled bar 14 extending within the plane of barrier 10 inside the frame. Angled bar 14 is fixed relative to the frame. Here, a lower end of angled bar 14 is connected to lower pole 12 and an upper end of angled bar 14 is connected to second vertical upright 13b. Alternatively, the lower end of angled bar 14 can be connected to second vertical upright 13b and/or the upper end of angled bar 14 can be connected to upper pole 11.

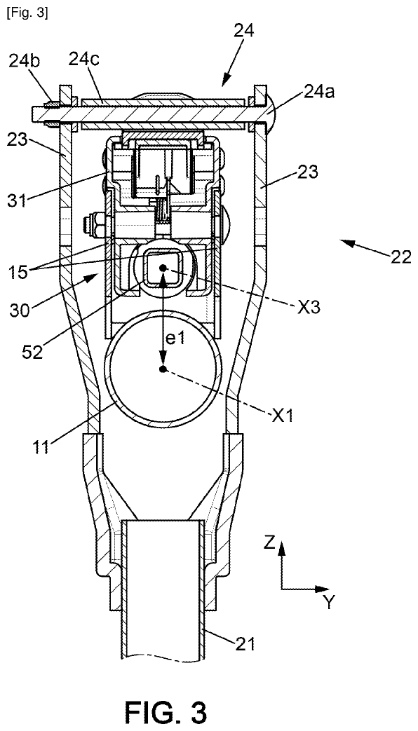

Barrier 10 also comprises a swing arm 20. Swing arm 20 comprises a tubular arm 21 and a fork 22. Fork 22 is integral with an upper end of arm 21. Fork 22 comprises a pair of prongs 23 arranged one on either side of upper pole 11 in transverse direction Y. In other words, upper pole 11 is arranged, in transverse direction Y, between prongs 23 of fork 22 of swing arm 20. Swing arm 20 further comprises a rod 24 extending transversely between prongs 23 of fork 22. Rod 24 is rigidly connected to each of prongs 23 of fork 22. As shown in FIG. 3, rod 24 here comprises a screw 24a and a nut 24b. Screw 24a passes through a hole formed in each of prongs 23 of fork 22. Screw 24a has a head resting, in the transverse direction Y, on an outer face of one of prongs 23, and nut 24b is screwed onto screw 24a so as to be tightened on the outer face of the other of prongs 23. “Outer faces” of prongs 23 is understood to mean the faces of prongs 23 which are facing away from one another. Rod 24 here comprises a sheath 24c covering the portion of screw 24a which is located between prongs 23 in transverse direction Y. The sheath can, for example, be made of plastic. Finally, and in a noteworthy manner, rod 24 is arranged above upper pole 11 in vertical direction Z.

Swing arm 20 is mounted so as to pivot relative to the frame about a first transverse axis Y1. In particular, arm 21 of swing arm 20 is hinged here so as to pivot about the first transverse axis Y1 relative to a base which is integral with angled bar 14. Consequently, when swing arm 20 pivots, rod 24 of swing arm 20 has a path which forms an arc of a circle around first transverse axis Y1. Swing arm 20 can in particular pivot between an open position O allowing the passage of an animal's head in an upper part of the frame and a release position D allowing the animal to access a trough to feed and/or to withdraw its head through a lower part of the frame. In other words, in the open position O, swing arm 20 is in a position such that a lower part of arm 21 of swing arm 20 obstructs the lower part of the frame. The passage of an animal's head through the frame is then only permitted in the upper part of the frame, longitudinally between an upper part of arm 21 of swing arm 20 and the first vertical upright 13a. In the release position D, swing arm 20 is in a position such that an upper part of arm 21 of swing arm 20 obstructs the upper part of the frame. The passage of an animal's head through the frame is then only permitted in the lower part of the frame, longitudinally between a lower part of arm 21 of swing arm 20 and the first vertical upright 13a.

The ability to lock swing arm 20 in a locking position F is further provided. In locking position F, arm 21 of swing arm 20 extends here in vertical direction Z. Thus, in the locking position, arm 21 of swing arm 20 forms, with first vertical upright 13a, a passage whose spacing, in longitudinal direction X, is identical over the entire vertical dimension of the frame. This defines a closed position, which allows either denying an animal access through the frame, or hobbling the animal by the neck.

To achieve this, barrier 10 comprises a locking mechanism 30. Locking mechanism 30 comprises a plate 31 fixed to upper pole 11. Plate 31 is in the form of a housing defining an interior volume. Plate 31 comprises a first flange 31a and a second flange 31b which are assembled together in transverse direction Y, for example by screwing, riveting, gluing, or interlocking. Plate 31 is arranged transversely between two longitudinal walls 15 of barrier 10, which are integral with upper pole 11. Each flange 31a, 31b of plate 31 is fixed to a respective longitudinal wall 15, for example by bolting, screwing, riveting, or gluing. Finally, the circular path of rod 24 about first transverse axis Y1 circles around plate 31.

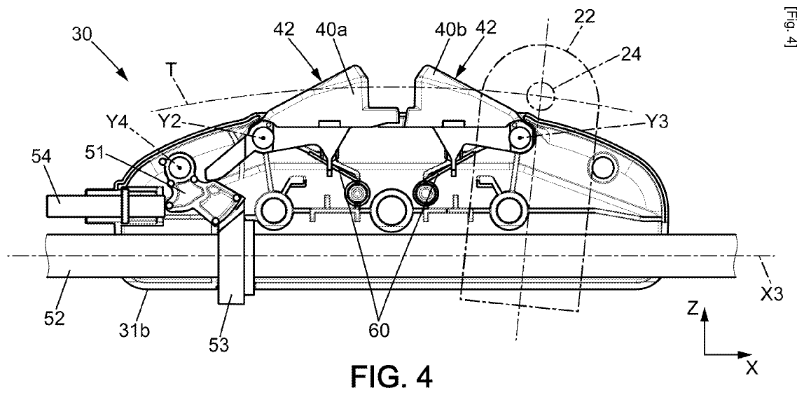

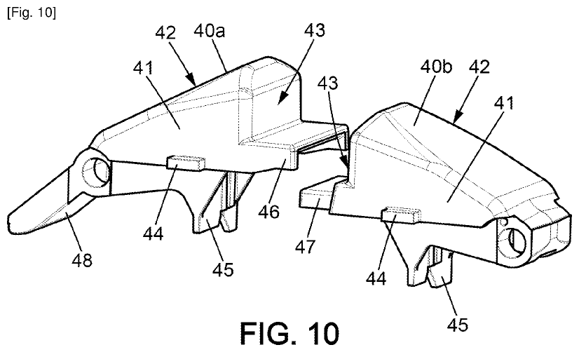

The locking mechanism is more particularly visible in FIGS. 4 to 9. Locking mechanism 30 comprises a first stop wedge 40a and a second stop wedge 40b, shown in isolation in FIG. 10. First stop wedge 40a and second stop wedge 40b each comprise a main body 41 which has at least one upper face 42 and one side face 43. First stop wedge 40a and second stop wedge 40b are each received partly inside the interior volume defined by plate 31. To this effect, an upper wall of plate 31 has an opening through which first stop wedge 40a and second stop wedge 40b are received. First stop wedge 40a and second stop wedge 40b are hinged so as to pivot relative to plate 31, respectively about a second transverse axis Y2 and a third transverse axis Y3. Thus, first stop wedge 40a and second stop wedge 40b pivot while remaining within the plane of barrier 10. This prevents in particular the protrusion of stop wedges 40a, 40b to either side of the frame in transverse direction Y, i.e. outside the plane of barrier 10, during their pivoting about second transverse axis Y2 and third transverse axis Y3, which would pose a risk of injuring an animal or a human operator. First stop wedge 40a and second stop wedge 40b are in particular hinged so as to pivot between a deployed position and a retracted position.

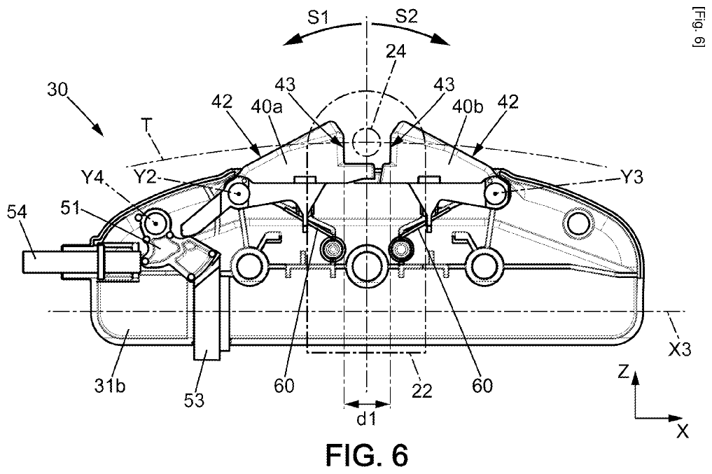

As shown in FIG. 6, in the deployed position, first stop wedge 40a and second stop wedge 40b are adapted to cooperate with rod 24 of swing arm 20 in order to prevent swing arm 20 from pivoting about first transverse axis Y1 in the locking position relative to the frame. In their deployed position, first stop wedge 40a and second stop wedge 40b are adapted to prevent a circular movement of rod 24 of swing arm 20 about first transverse axis Y1. In particular, in their deployed position, first stop wedge 40a is adapted to prevent a circular movement of rod 24 about first transverse axis Y1 in a first direction S1 of rotation, and second stop wedge 40b is adapted to prevent a circular movement of rod 24 about first transverse axis Y1 in a second direction S2 of rotation. In their deployed position, side face 43 of each stop wedge 40a, 40b extends perpendicularly to longitudinal direction X. In their deployed position, side face 43 of each stop wedge 40a, 40b thus forms a stop adapted to prevent a circular movement of rod 24 of swing arm 20 about first transverse axis Y1, respectively in first direction S1 of rotation and second direction S2 of rotation. In other words, when first stop wedge 40a and second stop wedge 40b are in the deployed position, a free space is formed longitudinally between first stop wedge 40a and second stop wedge 40b, the free space being adapted to receive rod 24 of swing arm 20. Thus, in the locking position of swing arm 20, rod 24 is longitudinally arranged in the free space between first stop wedge 40a and second stop wedge 40b so as to block the pivoting of swing arm 20 about first transverse axis Y1. However, it is not excluded that there be play in longitudinal direction X, on each side, between rod 24 and each stop wedge 40a, 40b when the former is arranged longitudinally between first stop wedge 40a and second stop wedge 40b in their deployed position. First stop wedge 40a and second stop wedge 40b are each made of plastic. This reduces the level of noise emitted when rod 24 of swing arm 20 strikes one of stop wedges 40a, 40b.

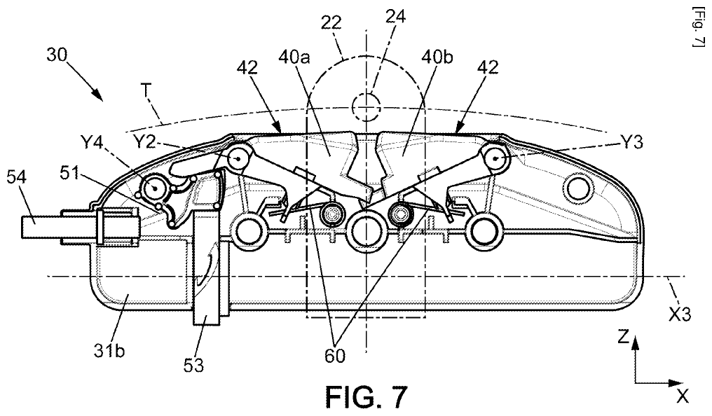

In the retracted position, visible in FIGS. 7 to 9, swing arm 20 can pivot freely about first transverse axis Y1 relative to the frame. When first stop wedge 40a and second stop wedge 40b are each in their retracted position, swing arm 20 can pivot about first transverse axis Y1 without rod 24 bumping against first stop wedge 40a or second stop wedge 40b. In other words, first stop wedge 40a and second stop wedge 40b are each arranged at a distance from the path of rod 24 about first transverse axis Y1. In the retracted position, here each stop wedge 40a, 40b is received within the interior volume defined by plate 31 more than it is in the deployed position.

First stop wedge 40a and second stop wedge 40b are each adapted to be moved from the deployed position to the retracted position under the effect of the pivoting of swing arm 20 towards the locking position, respectively in second direction S2 for stop wedge 40a and in first direction S1 for stop wedge 40b. This allows automatically moving first stop wedge 40a and/or second stop wedge 40b out of the way. Rod 24 of swing arm 20 can thus be brought to cooperate with first stop wedge 40a and second stop wedge 40b without it being necessary to act directly and manually on locking mechanism 30. Locking swing arm 20 is therefore easy and fast. In addition, the risk of injury to a human operator is avoided. To achieve this, upper face 42 of first stop wedge 40a and of second stop wedge 40b are each shaped so that the bearing of rod 24 of swing arm 20 against the upper face 42 in question during its pivoting of swing arm 20 towards the locking position is capable of moving respective stop wedge 40a, 40b from the deployed position to the retracted position. To achieve this, upper face 42 of each stop wedge 40a, 40b is here inclined relative to longitudinal direction X. When swing arm 20 pivots about first transverse axis Y1 towards the locking position, rod 24 presses on upper face 42 of first stop wedge 40a in its deployed position or on upper face 42 of second stop wedge 40b in its deployed position, in direction S1, S2 of rotation of swing arm 20 about first transverse axis Y1 so as to drive the stop wedge 40a, 40b concerned, by ramp effect, to rotate respectively about second transverse axis Y2 or third transverse axis Y3.

The free space formed between first stop wedge 40a and second stop wedge 40b in their deployed position can have a dimension d1 measured in longitudinal direction X enabling each stop wedge 40a, 40b to pivot between the deployed position and the retracted position when rod 24 of swing arm 20 is received in the free space. A pinching of rod 24 of swing arm 20 is thus avoided when each stop wedge 40a, 40b pivots from the deployed position to the retracted position, which would cause locking mechanism 30 to jam.

Locking mechanism 30 further comprises means adapted to ensure a return of first stop wedge 40a and second stop wedge 40b to the deployed position. Thus, first stop wedge 40a and second stop wedge 40b are each adapted to be moved from the retracted position to the deployed position when swing arm 20 is in the locking position. This allows robust locking of swing arm 20 and automatic return of first stop wedge 40a and second stop wedge 40b to their deployed position. In the absence of external stresses applied to first stop wedge 40a and to second stop wedge 40b, these means also ensure that first stop wedge 40a and second stop wedge 40b are maintained in their deployed position. In the example shown, these are elastic means. Elastic means are an economical and reliable solution for returning first stop wedge 40a and second stop wedge 40b to the deployed position. However, it is not excluded that other types of means are provided, for example motorized means suitable for driving each stop wedge 40a, 40b about its respective transverse axis of rotation.

The elastic means comprise a first torsion spring 60 and a second torsion spring 60. First torsion spring 60 is interposed between a first transverse appendage of plate 31 and a tab 45 of first stop wedge 40a. Second torsion spring 60 is interposed between a second transverse appendage of plate 31 and a tab 45 of second stop wedge 40b. First torsion spring 60 and second torsion spring 60 are arranged inside the interior volume defined by plate 31.

To maintain first stop wedge 40a and second stop wedge 40b in their deployed position under the action of the elastic means, provision may be made for first stop wedge 40a and second stop wedge 40b to be in abutment against an inner face of plate 31. To achieve this, here each stop wedge 40a, 40b comprises two lugs 44, of which one is visible for each stop wedge 40a, 40b in FIG. 10. Lugs 44 of each stop wedge 40a, 40b extend transversely to either side of the main body 41 of respective stop wedge 40a, 40b. Lugs 44 of each stop wedge 40a, 40b are intended to be in abutment, in vertical direction Z, against an inner face of plate 31 when the respective stop wedge is in the deployed position.

Reference is now made to FIGS. 4 to 6 which illustrate locking mechanism 30 in different configurations during the pivoting of swing arm 20 about first transverse axis Y1 from open position O to locking position F.

In the configuration of FIG. 4, swing arm 20 is in an intermediate position between closed position F and open position O in which rod 24 of swing arm 20 does not interact with first stop wedge 40a nor with second stop wedge 40b. Thus, first stop wedge 40a and second stop wedge 40b are each held in their deployed position by the action of the elastic means.

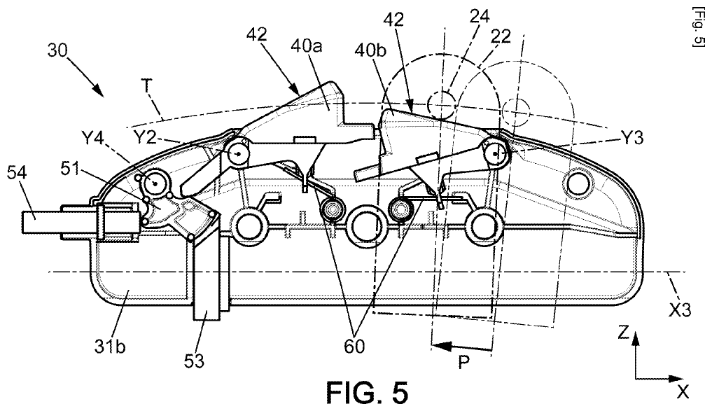

In the configuration shown in FIG. 5, swing arm 20 pivots further about first transverse axis Y1 from open position O to closed position F as shown by arrow P. Rod 24 is therefore rotated about first transverse axis Y1 until it bears against upper face 42 of second stop wedge 40b in its deployed position. Continuing the pivoting of swing arm 20 towards the locking position generates a ramp effect of rod 24 on the upper face of second stop wedge 40b so as to drive it to rotate about third transverse axis Y3 towards its retracted position, as can be seen in FIG. 5. It is noteworthy that second stop wedge 40b here is moved from the deployed position to the retracted position independently of a movement of first stop wedge 40a. Rod 24 then continues its travel about first transverse axis Y1 until it abuts against side face 43 of first stop wedge 40a.

Finally, in the configuration of FIG. 6, swing arm 20 is in its locking position F. Rod 24 of swing arm 20 no longer rests against second stop wedge 40b. Second stop wedge 40b is therefore moved towards its deployed position under the action of the elastic means.

As is more particularly visible in FIG. 10, first stop wedge 40a cooperates with second stop wedge 40b so that a movement of first stop wedge 40a from the deployed position to the retracted position causes a movement of second stop wedge 40b from the deployed position to the retracted position. Conversely, a movement of second stop wedge 40b from the retracted position to the deployed position is able to cause a movement of first stop wedge 40a from the retracted position to the deployed position. First stop wedge 40a comprises a projecting portion 46 resting in the vertical direction on a projecting portion 47 of second stop wedge 40b. This makes it possible to reduce the space occupied by locking mechanism 30. More particularly, this makes it possible to reduce the space occupied by first stop wedge 40a and second stop wedge 40b inside the interior volume defined by plate 31. Also, projecting portion 46 of first stop wedge 40a can be U-shaped so as to cover projecting portion 47 of second stop wedge 40b. In particular, projecting portion 46 of first stop wedge 40a transversely frames projecting portion 47 of second stop wedge 40b. This makes it possible to avoid displacement of one of stop wedges 40a, 40b relative to the other in transverse direction Y.

A barrier 10 as described above provides robust locking of swing arm 20 relative to the frame. In particular, fork 22 of swing arm 20 is devoid of any movable or sliding element necessary for locking swing arm 20. Also, the risks of obstruction or clogging of locking mechanism 30, due to residues, are reduced or even prevented. Furthermore, such an arrangement allows the passage of rod 24 to secure prongs 23 of fork 22, thus permitting increased mechanical strength of prongs 23 of fork 22 relative to each other.

Finally, with reference to FIGS. 7 to 9, locking mechanism 30 comprises a control member adapted to move first stop wedge 40a from the deployed position to the retracted position. By means of the cooperation of first stop wedge 40a with second stop wedge 40b described above, the control member therefore allows moving second stop wedge 40b from the deployed position to the retracted position via first stop wedge 40a. The control member therefore allows releasing swing arm 20 when the arm is prevented from pivoting in the locking position.

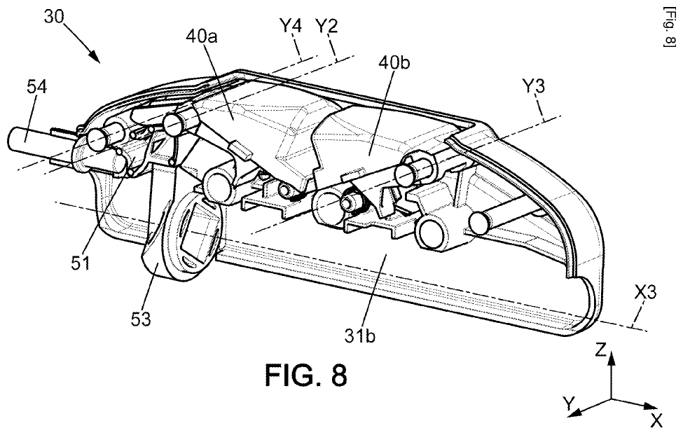

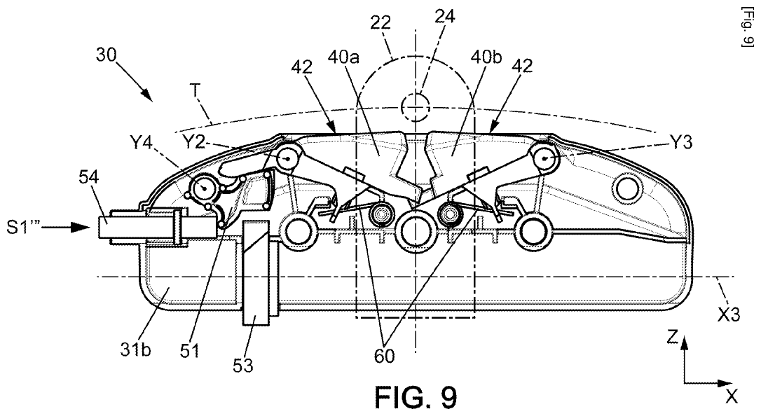

The control member here comprises a collective unlocking control and an individual unlocking control. The collective unlocking control and the individual unlocking control are independent of each other and each allows controlling first stop wedge 40a and second stop wedge 40b from the deployed position to the retracted position. FIGS. 7 and 8 show a configuration of locking mechanism 30 when using the collective unlocking control and FIG. 9 shows a configuration of locking mechanism 30 when using the individual control.

The control member also comprises a connecting member 51 mounted so as to pivot relative to plate 31 about a fourth transverse axis Y4. Connecting member 51 is interposed between the collective unlocking control and first stop wedge 40a on the one hand, and between the individual unlocking control and first stop wedge 40a on the other hand. Connecting member 51 is arranged inside the interior volume defined by plate 31.

Connecting member 51 cooperates with first stop wedge 40a such that a rotation of connecting member 51 about fourth transverse axis Y4 in a first direction S1′ causes a rotation of first stop wedge 40a about second transverse axis Y2 from the deployed position to the retracted position. To this end, connecting member 51 bears against a bearing wall 48 of first stop wedge 40a, in particular on a lower face of bearing wall 48.

The collective unlocking control comprises a bar 52 extending longitudinally along a third transverse axis Y3. The unlocking control also comprises a cam 53 fixedly mounted on bar 52 so as to rotate about third longitudinal axis X3. To achieve this, bar 52 has a square-shaped cross-section and cam 53 has a hole 53a traversed by bar 52, hole 53a having a shape suitable to be associated with bar 52 due to complementary shapes and to allow connecting bar 52 and cam 53 to be integral in rotation about third longitudinal axis X3. Here, hole 53a of cam 53 is also square in shape.

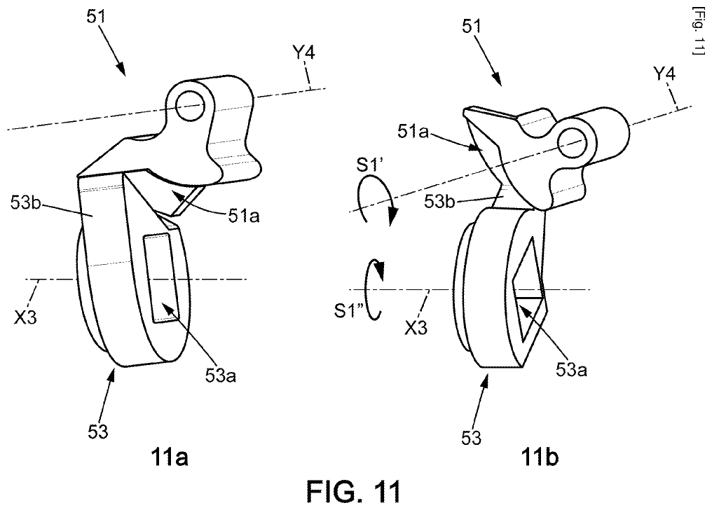

As shown in FIG. 11, cam 53 cooperates with connecting member 51 so that a rotation of bar 52 and cam 53 about third longitudinal axis X3 in a first direction S1″ causes a rotation of connecting member 51 about fourth transverse axis Y4 in first direction S1′. To achieve this, cam 53 comprises a relief 53b which cooperates by ramp effect with a helical wall 51a of connecting member 51.

Thus, by means of the arrangement of the collective unlocking control, a rotation of bar 52 about third longitudinal axis X3 controls a rotation of first stop wedge 40a about second transverse axis Y2 from the deployed position to the retracted position. The cooperation between cam 53 and the control member is such that first stop wedge 40a is moved from the deployed position to the retracted position by a rotation of bar 52, about third longitudinal axis X3 over an angular sector equal to 45°. Rotation of bar 52 over a small angular sector allows easy use of bar 52 by an operator of barrier 10.

Advantageously, bar 52 is not exposed to the forces induced by an animal on swing arm 20. In addition, bar 52 only undergoes torsional forces. In particular, the bar 52 does not undergo any bending force and does not undergo any cantilever force.

Bar 52 traverses plate 31 of locking mechanism 30 from one end to the other in longitudinal direction X. Bar 52 can thus extend longitudinally over the entire length of upper pole 11 so as to allow simultaneous control of a plurality of locking mechanisms carried by upper pole 11.

Bar 52 is also arranged, in vertical direction Z, between upper pole 11 and rod 24 of swing arm 20. Such an arrangement allows bar 52 to be placed as close as possible to upper pole 11 in vertical direction Z. In other words, this allows reducing the spacing el between first longitudinal axis X1 and third longitudinal axis X3, which reduces the space occupied by the arrangement.

The individual unlocking control comprises a push-button 54. Push-button 54 extends in longitudinal direction X. Push-button 54 cooperates with connecting member 51 so that a translational movement of push-button 54 in longitudinal direction X along a first direction S1′″ of translation causes rotation of connecting member 51 about fourth transverse axis Y4 in first direction S1′. To achieve this, push-button 54 bears, in longitudinal direction X, against connecting member 51 at a distance from fourth transverse axis Y4 in vertical direction Z. Moreover, push-button 54 extends partly outside plate 31 so as to be accessible to a human operator by using his hand or by using a pitchfork handle or any other tool. Indeed, the pitchfork handle or any other tool can be slid on bar 52 to strike push-button 54 and thus cause retraction of first stop wedge 40a. Plate 31 has a hole on one side face, which is traversed by push-button 54. The individual unlocking control allows selectively unlocking a locking mechanism 30, in particular when barrier 10 comprises a plurality of locking mechanisms carried by upper pole 11.

The control member is described above as an example. Provision may be made for selective or grouped control, possibly actuated remotely. It is not excluded to provide another type of control member. For example, according to a variant embodiment, a control member may be provided which is arranged to allow motorization in which the kinematics concern translational and/or rotational movement.

1. Headlock-type barrier comprising:
a. an upper pole and a lower pole each extending in a longitudinal direction;
b. a pair of vertical uprights each connected to the lower pole and to the upper pole so as to define a frame,
c. a swing arm mounted so as to pivot relative to the frame about a first transverse axis, the swing arm comprising an arm and a fork which is integral with an upper end of the arm, the fork comprising a pair of prongs arranged one on either side of the upper pole in the transverse direction, the swing arm further comprising a rod rigidly connected to each of the prongs of the fork, the rod being arranged above the upper pole in the vertical direction,
d. a locking mechanism comprising a plate fixed to the upper pole and on which are hinged a first stop wedge and a second stop wedge between a deployed position in which the first stop wedge and the second stop wedge are adapted to cooperate with the rod of the swing arm in order to block the pivoting of the swing arm about the first transverse axis in a locking position relative to the frame, and a retracted position in which the swing arm can pivot freely about the first transverse axis relative to the frame,
e. a control member adapted to move the first stop wedge and/or the second stop wedge from the deployed position to the retracted position.

2. The headlock-type barrier according to claim 1, wherein the first stop wedge and the second stop wedge are hinged so as to pivot relative to the plate, respectively about a second transverse axis and a third transverse axis.

3. The headlock-type barrier according to claim 1, wherein the first stop wedge and/or the second stop wedge are each adapted to be moved from the deployed position to the retracted position under the effect of the pivoting of the swing arm towards the locking position.

4. The headlock-type barrier according to claim 1, wherein the first stop wedge cooperates with the second stop wedge so that a movement of the first stop wedge from the deployed position to the retracted position causes a movement of the second stop wedge from the deployed position to the retracted position.

5. The headlock-type barrier according to claim 1, wherein the locking mechanism comprises means adapted to ensure a return of the first stop wedge and the second stop wedge to the deployed position.

6. The headlock-type barrier according to claim 5, wherein said means comprise elastic means.

7. The headlock-type barrier according to claim 1, wherein the control member comprises a collective unlocking control which comprises a bar extending parallel to the upper pole, the bar being arranged, in the vertical direction, between the upper pole and the rod of the swing arm, and wherein a rotation of the bar about the bar's axis of extension causes the first stop wedge and/or the second stop wedge to move from the deployed position to the retracted position.

8. The headlock-type barrier according to claim 1, wherein the locking mechanism comprises an individual unlocking control which comprises at least one push-button shaped to move one among the first stop wedge and the second stop wedge from the deployed position to the retracted position.

9. The headlock-type barrier according to claim 8,
wherein the control member comprises a collective unlocking control which comprises a bar extending parallel to the upper pole, the bar being arranged, in the vertical direction, between the upper pole and the rod of the swing arm, and wherein a rotation of the bar about the bar's axis of extension causes the first stop wedge and/or the second stop wedge to move from the deployed position to the retracted position, and
wherein the control member comprises a connecting member mounted so as to pivot relative to the plate about a fourth transverse axis, the connecting member being interposed between the bar and one among the first stop wedge and the second stop wedge on the one hand, and between the push-button and said stop wedge in question among the first stop wedge and the second stop wedge on the other hand.

10. The headlock-type barrier according to claim 1, wherein the first stop wedge and the second stop wedge are each made of plastic.
